(19) United States
(12) Patent Application Publication
(10) Pub. No.: US 2020/0102028 A1
(43) Pub. Date: Apr. 2, 2020

(54) ADJUSTABLE CRADLE FOR MOVEMENT OF AN AUTOMOTIVE SPARE TIRE

(71) Applicant: FORD GLOBAL TECHNOLOGIES, LLC, DEARBORN, MI (US)

(72) Inventors: Gonzalo Anzaldo Muñoz, San Mateo Atenco (MX); Rafael Uscanga Ruiz, Coacalco (MX); Luis Fernando Hernández Aguilera, Colonia Barrio San Marcos (MX); Alejandro Sánchez López, Del Iztacalco (MX); Olmo Dario Villegas López, Coyoacán (MX)

(21) Appl. No.: 16/148,143

(22) Filed: Oct. 1, 2018

(51) Int. Cl. B62D 43/04; B62D 43/00

(52) U.S. Cl. CPC B62D 43/04; B62D 43/005; B62D 43/002

(57) ABSTRACT

A cradle for a spare tire includes a hub, arms extending from the hub, fasteners configured to secure the spare tire to the cradle, and wheels on the arms to support the cradle for movement. The arms have adjustable radial lengths. The fasteners are adjustable for different tire sizes.

### BACKGROUND OF INVENTION

The present invention relates to a cradle for a spare tire of an automotive vehicle and in particular to a transport cradle used to move the spare tire.

An automotive vehicle is typically provided with a spare tire that is pre-mounted on a wheel. The spare tire is stored on the vehicle and used when a regular tire of the vehicle is unable to be used and needing to be replaced. For example, the regular tire needing to be replaced may be flat or deflated. For many vehicles, such as pickup trucks and sport utility vehicles, it is common to store the spare tire underneath the bed or rear body of the vehicle such that the spare tire is accessed from below the vehicle. When the spare tire is needed, it is lowered to the ground by a crank and then moved—e.g., dragged—out from under the vehicle. The spare tire must then also be moved—e.g., dragged or stood up and rolled—to the regular tire being replaced. These movements of the spare tire require physical strength that not all persons possess.

### SUMMARY OF INVENTION

An embodiment contemplates a cradle for a spare tire having a hub, arms extending from the hub, and fasteners configured to secure the spare tire to the cradle. The arms have adjustable lengths.

Another embodiment contemplates a cradle for a spare tire having a hub, arms extending from the hub, fasteners configured to secure the spare tire to the cradle, and wheels on the arms to support the cradle for movement. The arms have adjustable radial lengths. The fasteners are adjustable for different tire sizes.

Another embodiment contemplates a cradle for a spare tire having a hub, an opening in the hub, arms extending from the hub, a receptacle on at least one of the arms, adjustable straps configured to secure the spare tire to the cradle, and casters on the arms to support the cradle for movement. The opening in the hub is configured to receive a lifting mechanism. The arms are adjustable between a first position to support a first size of spare tire and a second position to support a second size of spare tire. The receptacle is configured to receive a handle to move the cradle. The fasteners are adjustable between a first fastener length to secure the first size of spare tire and a second fastener length to secure the second size of spare tire.

An advantage of an embodiment is a cradle that is adjustable to accommodate different sizes of spare tires. Another advantage of an embodiment is that the adjustable cradle is still compact, to fit within and support the spare tire in the packaging space available for the spare tire, and includes wheels, to assist with easily moving the tire where desired.

### BRIEF DESCRIPTION OF DRAWINGS

FIG. 1 is a first perspective view of a cradle for a spare tire.

FIG. 2 is an enlarged portion of FIG. 1.

FIG. 3 is a second perspective view of the cradle of FIG. 1 mounted to a vehicle.

FIG. 4 is a first bottom elevation view of the cradle of FIG. 1 with the spare tire of FIGS. 1 and 2.

FIG. 5 is a section view taken along line 5-5 of FIG. 4.

FIG. 6 is a second bottom elevation view of the cradle of FIG. 1 adjusted to accommodate a second spare tire having a different size than the spare tire of FIGS. 1 and 2.

FIG. 7 is a section view taken along line 7-7 of FIG. 6.

FIG. 8 is a schematic view of a first step in using the cradle of FIG. 1.

FIG. 9 is a schematic view of a second step in using the cradle of FIG. 1.

### DETAILED DESCRIPTION

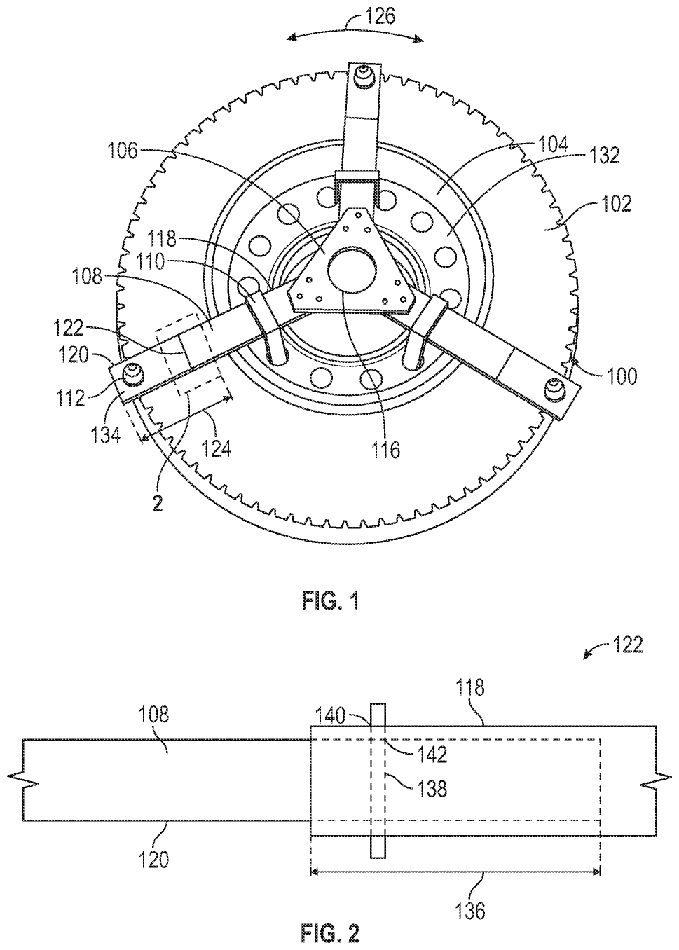

Referring now to FIG. 1, there is illustrated a spare tire transport cradle, indicated generally at 100, for use with a spare tire 102. The spare tire 102 is of a type known to those skilled in the art. As illustrated, the spare tire 102 is mounted to a wheel 104. As used herein, reference to the “spare tire” includes the wheel 104 unless otherwise noted. Also, as illustrated, the spare tire 102 is a full size spare tire. Alternatively, the spare tire 102 may be other than a full size spare tire. As a non-limiting example, the spare tire 102 may be a compact spare tire.

The cradle 100 includes a hub 106, three arms 108 extending from the hub 106, fasteners 110 configured to secure the spare tire 102 to the cradle 100, and wheels 112 for rolling or otherwise moving the cradle 100 on a roadway 114 (shown in FIGS. 5 and 7) or other surface. Discussion of one of the arms 108 applies to the other arms 108 unless otherwise noted.

The hub 106 interconnects the arms 108. Preferably, the hub 106 is a central portion of the cradle 100 from which the arms 108 extend. As illustrated, the hub 106 is provided with a lifting opening 116 that will be discussed further. As illustrated, the lifting opening 116 is circular in shape and extends through the hub 106. Alternatively, the lifting opening 116 may be any other shape to receive a hook and/or not extend through the hub 106. Alternatively, the lifting opening 116 may be omitted from the hub 106 and/or provided on the arms 108.

The arms 108 comprise first and second portions 118 and 120, respectively. As will be discussed with reference to FIG. 2, positions of the first and second portions 118 and 120, respectively, are adjustable relative to each other at an interface, indicated generally at 122. As illustrated, each of the arms 108 includes the adjustable first and second portions 118 and 120, respectively. Alternatively, less than all of the arms 108 may include the adjustable first and second portions 118 and 120, respectively. Preferably, three of the arms 108 are provided for the cradle 100. Alternatively, two or more than three arms 108 may be provided.

The arms 108 extend outwardly from the hub 106. Each of the arms 108 has a radial length 124. The radial length 124 is adjustable by changing positions of the first and second portions 118 and 120, respectively, relative to each other at the adjustable interface 122. Preferably, each of the arms 108 has an equal radial length 124 although, alternatively, one or more of the arms 108 may have a different radial length 124.

As illustrated, the radial length 124 for each of the arms 108 is adjustable. Alternatively, the radial length 124 of less than all of the arms 108 may be adjustable. As illustrated, the arms 108 are equally spaced in a circumferential direction 126. Alternatively, the arms 108 may be spaced other than evenly in the circumferential direction 126.

Preferably, the arms 108 are rigid members rigidly fixed to the hub 106. As non-limiting examples, the arms 108 may be fabricated from metal or plastic material. As a non-limiting example, the arms 108 may be tubular metal members. The arms 108 may be formed monolithically with the hub 106 or as separate members that are fixed or otherwise attached to the hub 106. Alternatively, the arms 108 may be other than rigid members and/or rigidly fixed to the hub 106.

Furthermore, each of the arms 108 is preferably provided with a receptacle 128 used for moving the cradle 100 and spare tire 102. The receptacle is provided on a topside 130 of the arms 108. As illustrated, the receptacle will be discussed further with reference to FIG. 9. Alternatively, the receptacle 128 may be provided on less than each of the arms 108, other than as illustrated, or omitted.

The fasteners 110 are provided on each of the arms 108. As discussed, the fasteners 110 secure and hold the spare tire 102 to the cradle 100. As a non-limiting example, the fasteners 110 prevent or otherwise reduce rotation of the spare tire 102 on the cradle 100 while the cradle 100 is being moved.

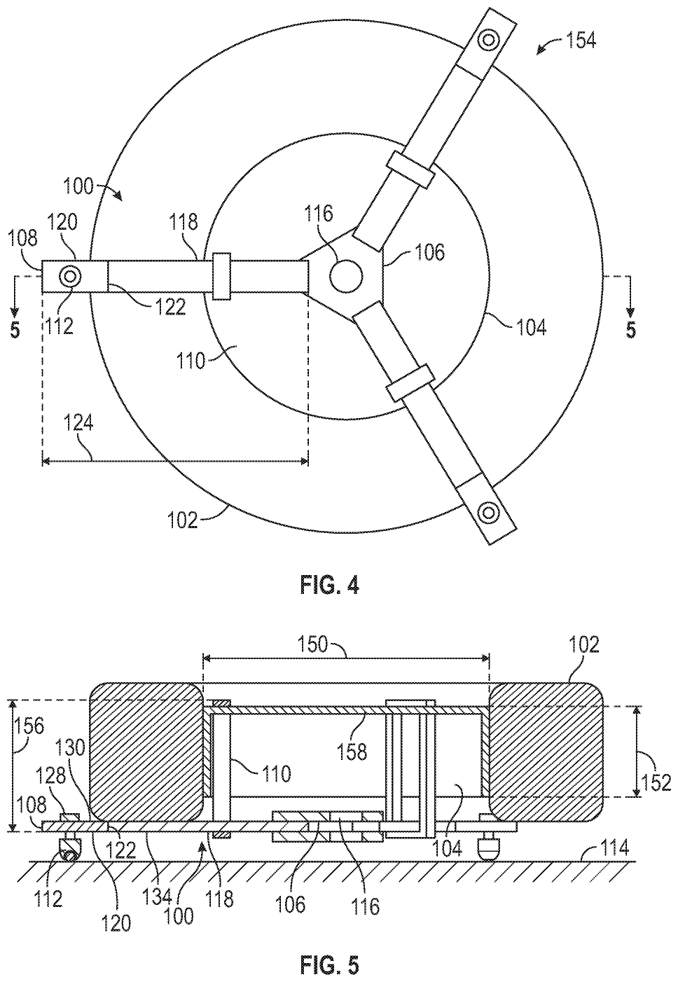

As will be discussed with reference to FIGS. 4-7, the fasteners 110 are adjustable to accommodate and secure different sizes of the spare tire 102 to the cradle 100. Preferably, each of the fasteners 110 is fixed or otherwise attached to one of the arms 108, although such is not necessary. As illustrated, the fasteners 110 are adjustable, flexible straps that form loops with adjustable lengths. Alternatively, as non-limiting examples, the fasteners may be flexible belts, screws, bolts, or clamps. As a further non-limiting example, the strap may have a hook and loop closure to provide adjustability. The fasteners 110 preferably thread or otherwise pass through and between openings 132 in the wheel 104 or around spokes of the wheel 104.

As shown in FIG. 1, the fasteners 110 are attached to the first portions 118. Alternatively, the fasteners 110 may be attached to the second portions 120 or the hub 106. Alternatively, positions where the fasteners 110 are attached on the arms 108 may be adjustable to accommodate the different sizes of the spare tire 102.

The wheels 112 are provided for the arms 108. The wheels 112 have a lower coefficient of friction when moving the cradle 100 than the spare tire 102 would have being pulled, dragged or otherwise moved directly on the roadway 114 without the cradle 100. Thus, effort and physical strength required to move the spare tire 102 are reduced by utilizing the cradle 100. Alternatively, structures other than the wheels 112, but still having a lower coefficient of friction, may be provided. As a non-limiting example, skids or rollers may be provided in lieu of the wheels 112.

As illustrated, each of the arms 108 has one of the wheels 112. Alternatively, each of the arms 108 may have more or less than one of the wheels 112. Preferably, the wheels 112 are casters but may also be of any type for rolling or otherwise moving the cradle 100 on the roadway 114, both with and without the spare tire 102 mounted to the cradle 100. As illustrated, the wheels 112 are mounted on an underside 134 of the arms 108. Preferably, when the wheels 112 are on the undersides 134, a thickness or other profile of the wheels 112 is minimized. Alternatively, the wheels 112 may be other than mounted on the underside 134 of the arms 108.

Referring now to FIG. 2, there is illustrated the adjustable arms 108 in detail. As shown in FIG. 2, each of the arms 108 is telescopically adjustable. The second portion 120 extends into the first portion 118 for an overlap distance 136. An extent that the second portion 120 extends into the first portion 118—i.e., the overlap distance 136—allows the radial length 124 of the arms 108 to be adjusted.

The first and second portions 118 and 120, respectively, are fixed in position relative to each other by a pin, clamp, or other mechanism 138. The mechanism 138 engages both the first and second portions 118 and 120, respectively. As illustrated, the mechanism 138 extends through first and second openings 140 and 142, respectively, in both the first and second portions 118 and 120, respectively. Alternatively, the arms 108 may be adjustable other than telescopically. As non-limiting examples, the first and second portions 118 and 120 may have a rack and pinion style adjustment.

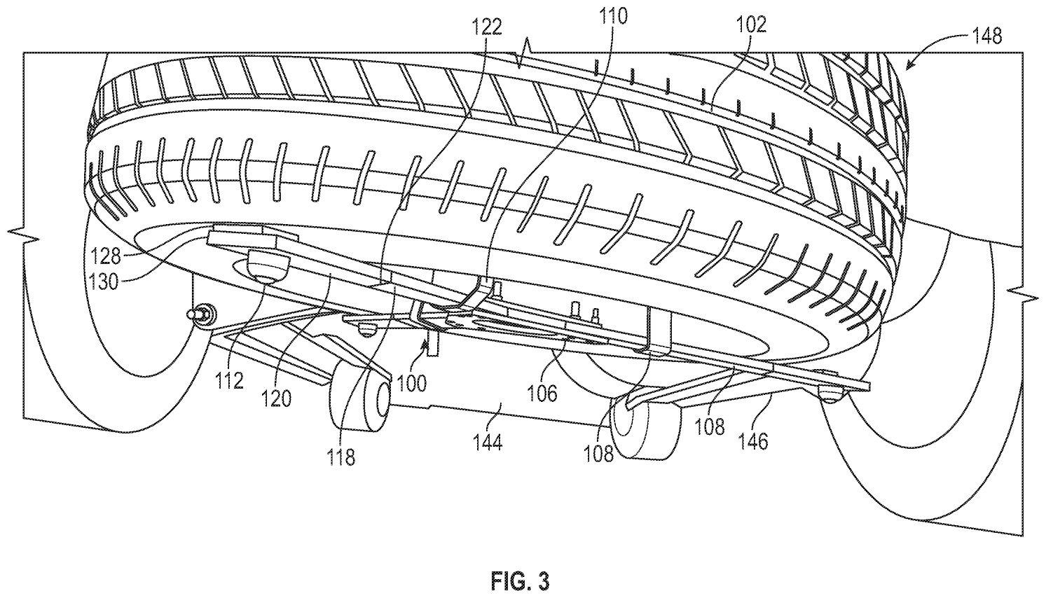

Referring now to FIG. 3, the spare tire 102 is mounted to an underside 144 of an automotive vehicle 146. As illustrated, the spare tire 102 is mounted at a rear portion, indicated generally at 148, of the vehicle 146. Alternatively, the spare tire 102 may be mounted other than as illustrated including other than to the underside of the vehicle 146 and/or at the rear portion 148 of the vehicle 146. The vehicle 146 may be any type of automotive vehicle. As non-limiting examples, the vehicle 146 may be a pickup truck or other type of truck, sport utility vehicle, or crossover type of vehicle. The spare tire 102 is preferably mounted to the vehicle 146 with the cradle 100 already mounted to the spare tire 102.

The lifting opening 116 receives a hook (not shown) or other mechanism for securing the spare tire 102 to a lifting mechanism that lifts and lowers the spare tire 102 from the underside 144 of the vehicle 146. As a non-limiting example, the lifting mechanism may be a cable and crank.

Referring now to FIGS. 4 and 5, there is illustrated the cradle 100 with the spare tire 102. The spare tire 102 has a first diameter 150 and a first depth 152. The arms 108 have the radial length 124. In FIGS. 4 and 5, the arms 108 are in a first position, indicated generally at 154 which supports or otherwise accommodates the spare tire 102. The fasteners 110 extend for a first fastener length 156.

As illustrated, the first fastener length 156 is between the arms 108 and a center portion 158 of the wheel 104. The first fastener length 156 is measured (and shown) in a direction substantially perpendicular to the roadway 114. As a result, a first actual length of one or more of the fasteners 110 between the arms 108 and the center portion 158 may be greater than the first fastener length 156. Such may occur when the wheel openings 132 do not align with—i.e., are circumferentially offset from—the arms 108.

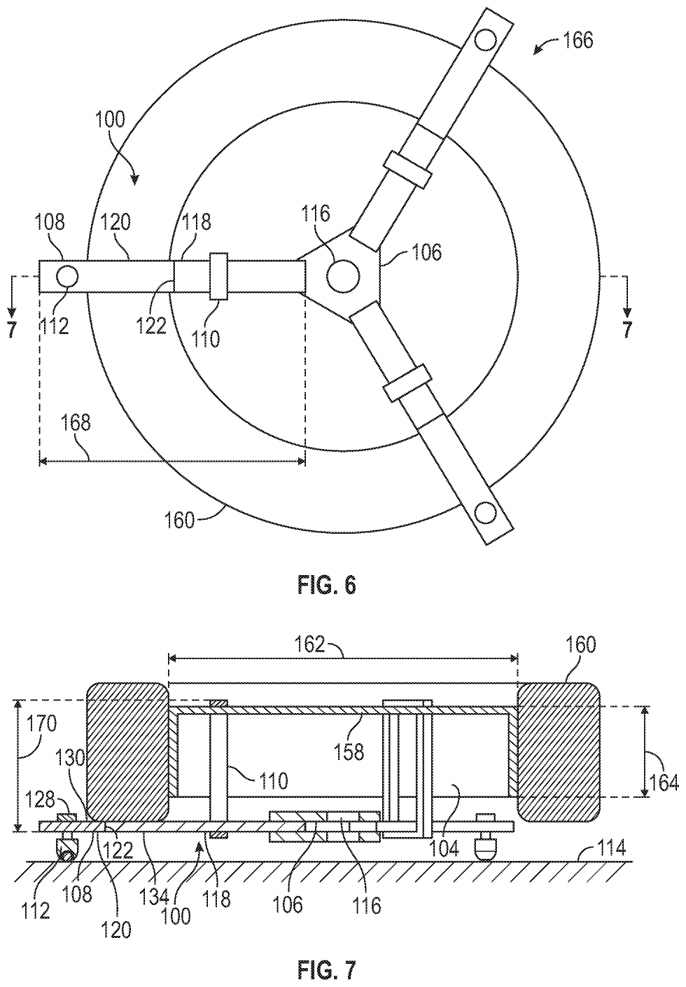

Referring now to FIGS. 6 and 7, there is illustrated the cradle 100 with a second spare tire 160. The second spare tire 160 has a second diameter 162 and a second depth 164. The second diameter 162 is greater than the first diameter 150 and the second depth 164 is greater than the first depth 152. Accordingly, the spare tire 102 and the second spare tire 160 have different sizes.

In FIGS. 6 and 7, the cradle 100 has been adjusted from as shown in FIGS. 4 and 5 to a second position, indicated generally at 166, to support or otherwise accommodate the larger size of the second spare tire 160. The arms 108 have been radially extended. The arms 108 of the cradle 100 have been adjusted to accommodate the larger second diameter 162 of the second spare tire 160 such that second radial lengths 168 are greater than the radial lengths 124 in FIGS. 4 and 5. The arms 108 are adjusted as previously discussed with reference to FIG. 2. Similarly, the fasteners 110 have been adjusted to accommodate the larger second depth 164 of the second spare tire 160. The actual lengths of the fasteners 110 are increased such that second fastener lengths 170 are greater than the first fastener lengths 156.

In FIGS. 6 and 7, both the second diameter 162 is different than the first diameter 150 and the second depth 164 is different than the first depth 152. Alternatively, only one of the second diameter 162 or the second depth 164 may be different than the first diameter 150 or the first depth 152, respectively. The cradle 100 is not limited to use with the spare tire 102 illustrated in FIGS. 4 and 5 or the second spare tire 160 illustrated in FIGS. 6 and 7.

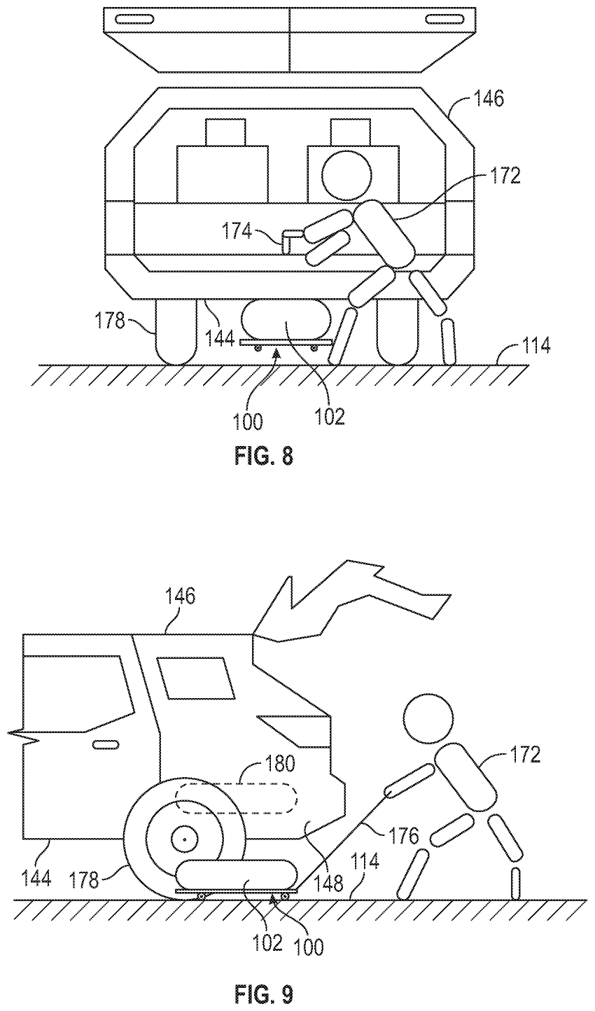

Referring now to FIG. 8, there is illustrated the cradle 100 and the spare tire 102 (mounted together) being lowered to the ground by a person 172. The person 172 is manually turning a crank 174 that lowers the cradle 100 and spare tire 102 from the underside 144 of the vehicle 146 to the roadway 114.

Referring now to FIG. 9, there is illustrated the person 172 moving—i.e., rolling—the spare tire 102 on the cradle 100 on the roadway 114 out from under the vehicle 146. The person 172 uses a handle 176 to pull the cradle 100 out from under the vehicle 146. The handle 176 attaches to the cradle 100 in the receptacle 128. Preferably, the handle 176 is a jack handle already provided for the vehicle 146. The person 172 then moves the spare tire 102 to a regular tire 178 of the vehicle 146 requiring replacement. Also illustrated in FIG. 9 by dashed lines is a stored position 180 of the cradle 100 and spare tire 102 on the underside 144 of the vehicle 146.

The cradle 100 may be used to assist in movement of tires other than the spare tire 102. As a non-limiting example, the cradle 100 may be used to move the regular tire 178 being replaced to the rear portion 148 for storage on the underside 144 of the vehicle 146.

While certain embodiments of the present invention have been described in detail, those familiar with the art to which this invention relates will recognize various alternative designs and embodiments for practicing the invention as defined by the following claims.

What is claimed is:

1. A cradle for a spare tire, the cradle comprising:
a hub;
arms extending from the hub, wherein the arms have adjustable radial lengths;
adjustable fasteners configured to secure the spare tire to the cradle.

2. The cradle of claim 1 further comprising:
an opening in the hub configured to receive a lifting mechanism for lifting the cradle.

3. The cradle of claim 1 wherein the arms are adjustable between a first position to support a first size of spare tire and a second position to support a second size of spare tire.

4. The cradle of claim 1 wherein the arms are telescopically adjustable.

5. The cradle of claim 1 wherein the fasteners are adjustable for different tire sizes.

6. The cradle of claim 1 wherein three arms extend from the hub.

7. The cradle of claim 1 wherein the arms are equally spaced in a circumferential direction.

8. The cradle of claim 1 further comprising a receptacle on at least one of the arms, wherein the receptacle is configured to receive a handle to move the cradle.

9. The cradle of claim 1 wherein at least one of the fasteners is fixed to at least one of the arms.

10. The cradle of claim 1 wherein the fasteners may be belts, screws, bolts, straps, or clamps.

11. The cradle of claim 1 wherein each of the fasteners forms a loop configured to be threaded through the spare tire and a length of the loop is adjustable.

12. The cradle of claim 1 further comprising:
wheels on the arms to support the cradle for movement.

13. The cradle of claim 12 wherein the wheels are casters.

14. The cradle of claim 12 wherein the wheels are on an underside of each of the arms.

15. A cradle for a spare tire, the cradle comprising:
a hub;
arms extending from the hub, wherein the arms have adjustable radial lengths;
fasteners configured to secure the spare tire to the cradle, wherein the fasteners are adjustable for different tire sizes;
wheels on the arms to support the cradle for movement.

16. The cradle of claim 15 wherein the arms are adjustable between a first position to support a first size of spare tire and a second position to support a second size of spare tire.

17. The cradle of claim 15 wherein the fasteners are adjustable for different tire sizes.

18. The cradle of claim 15 further comprising a receptacle on at least one of the arms, wherein the receptacle is configured to receive a handle to move the cradle.

19. A cradle for a spare tire, the cradle comprising:
a hub;
an opening in the hub configured to receive a lifting mechanism;
arms extending radially from the hub, wherein the arms are adjustable between a first position to support a first size of spare tire and a second position to support a second size of spare tire;
a receptacle on at least one of the arms, wherein the receptacle is configured to receive a handle to move the cradle;
adjustable straps configured to secure the spare tire to the cradle, wherein the straps are adjustable between a first fastener length to secure the first size of spare tire and a second fastener length to secure the second size of spare tire;
casters on the arms to support the cradle for movement.
